(19) United States
(12) Patent Application Publication
(10) Pub. No.: US 2026/0054393 A1
(43) Pub. Date: Feb. 26, 2026

(54) Robot Arrangement for an Automated Workspace Monitoring and Method

(71) Applicant: ABB Schweiz AG, Baden (CH)

(72) Inventors: Harald Staab, Neckargemünd (DE); Marco Baldini, Augsburg (DE); Bjoern Matthias, Bad Schönborn (DE); Fan Dai, Zwingenberg (DE); Christoph Byner, Mannheim (DE)

(73) Assignee: ABB Schweiz AG, Baden (CH)

(21) Appl. No.: 19/377,509

(22) Filed: Nov. 3, 2025

Related U.S. Application Data
(63) Continuation of application No. PCT/EP2023/061650, filed on May 3, 2023.

(51) Int. Cl. B25J 9/16

(52) U.S. Cl. CPC B25J 9/1697

(57) ABSTRACT

A robot arrangement includes at least a movable robot arm arrangement configured to move within a workspace defining a 3D motion range; a sensor arrangement installed on the robot arm arrangement comprising at least a first sensor device providing at least a first field of view; wherein the sensor arrangement is configured to be moved in such a way that the at least first field of view of the sensor arrangement covers at least a first portion of the workspace defining a first region of movement of the robot arm arrangement.

### CROSS-REFERENCE TO RELATED APPLICATIONS

The instant application claims priority to International Patent Application No. PCT/EP2023/061650, filed May 3, 2023, which is incorporated herein in its entirety by reference.

### FIELD OF THE DISCLOSURE

The present disclosure generally relates to a robot arrangement and an method for an automated motion monitoring of the robot arrangement.

### BACKGROUND OF THE INVENTION

Mobile installations of movable robot manipulator arms of a robot arrangement need to sense their immediate surroundings to avoid collision of the robot vehicle or the manipulator with objects or persons in the environment of the robot arrangement. The positioning and arrangement of sensors is part of this challenge to sense the environment of such a robot arrangement.

In the state of art safety laser scanners or safety light curtains are installed at a robot installation to detect if an object or person enters the hazardous perimeter of a robot. Safety laser scanners cover a plane with, usually, 270 degree scanning angle and are often mounted in parallel to the floor. Therefore, they can detect an approaching object or person and trigger a safe stop.

However, the trigger distance has to be set with a safety margin of usually larger than 1 m because undetected arm and hands can reach into the hazard zone, and because of worst case relative motion of person and robot towards each other.

Safety laser scanners and any other type of safety sensors always have a limited coverage of the 3D space, and limited resolution, but robot manipulators have a large 3D working envelope around their base. Thus, covering the working range of a robot arrangement by sensors and laser scanners during the movement of the robot arrangement is a challenge.

### BRIEF SUMMARY OF THE INVENTION

In one aspect, the present disclosure describes a robot arrangement that includes at least a movable robot arm arrangement that is configured to move within a workspace defining a 3D motion range; a sensor arrangement installed on the robot arm arrangement comprising at least a first sensor device providing at least a first field of view, wherein the sensor arrangement is configured to be moved in such a way that the at least first field of view of the sensor arrangement covers at least a first portion of the workspace defining a first region of movement of the robot arm arrangement.

In the context of the present disclosure, the sensor arrangement is installed on the robot arm arrangement and the movement of the sensor arrangement is controlled in such a way that a first field of view of the sensor arrangement covers at least a part of the workspace of the robot arm arrangement. The at least one part or portion of the workspace is equal to a first region of movement of the robot arm arrangement, i.e. the region into which the robot arm arrangement will move within the next seconds.

### BRIEF DESCRIPTION OF THE SEVERAL VIEWS OF THE DRAWING(S)

FIG. 1 is a diagram of a robot arrangement according to a first embodiment of the present disclosure.

FIG. 2a, FIG. 2b, and FIG. 2c are different perspective views of a robot arrangement according to a second embodiment of the present disclosure.

FIG. 3 is a diagram of a robot arrangement according to a third embodiment of the present disclosure.

### DETAILED DESCRIPTION OF THE INVENTION

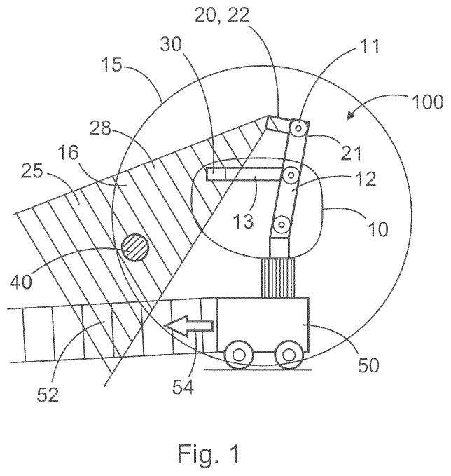

FIG. 1 illustrates a robot arrangement 100 according to a first embodiment of the present invention. The robot arrangement 100 comprises a movable robot arm arrangement 10 that is configured to move within a workspace 15 defining a 3D motion range, a sensor arrangement 20 installed on the robot arm arrangement 10 comprising a first sensor device 22 providing a first field of view 25. The sensor arrangement 20 is configured to be moved in such a way that the first field of view 25 of the sensor arrangement 20 covers a first portion 16 of the workspace 15 defining a first region of movement of the robot arm arrangement 10. The first region may also be named as a 3D volume.

According to FIG. 1, the robot arm arrangement 10 comprises a robot manipulator arm 13 and a tooling member 30 that is installed on the robot manipulator arm 13. The 3D volume is the 3D volume of the robot arrangement 10 and an installed tool or workpiece 30 adds its own 3D volume to the total 3D volume of the robot manipulator arm 13.

The sensor arrangement 20 may be installed on a moving part 12 of the robot arm arrangement 10 which is movable in various directions by joints of the robot arm arrangement 10. The moving part 12 may include the robot manipulator arm 13. Although not shown in FIG. 1, the sensor arrangement 20 may also and optionally directly installed on the robot manipulator arm 13.

According to FIG. 1, the sensor arrangement 20 is mounted on an independent joint 11 of the robot arm arrangement 10. The independent joint 11 is configured to move or to align the sensor arrangement 20 in a direction of the first portion 16 of the workspace 15 or corresponding to the first portion 16 of the workspace 15 of the robot arm arrangement 10.

Further, according to FIG. 1, independent joint 11 is configured to be moved or to move in such a way that the first field of view 25 of the sensor arrangement 20 covers the first portion 16 of the workspace 15 of the robot arm arrangement 10.

In an embodiment of the invention, the independent joint 11 which can comprise multiple independent joints is configured to move in such a way that its movement is coordinated with the movement of the robot arm arrangement 10 and a movement of the robot arrangement 100.

Further, according to FIG. 1, the sensor arrangement 20 is configured as an extension 21. This construction allows mounting of the first sensor device 22 at a defined distance relative to the robot arm arrangement 10, which allows the first sensing device 22 to monitor the first portion 16 of the workspace 15 of the robot arm arrangement 10.

In the embodiment of FIG. 1, the robot arrangement 100 is an autonomously guided vehicle 50 (AGV) on which the robot arm arrangement 10 is installed. The AGV 50 moves along a certain driving direction 54 depicted by the arrow sign. The AGV 50 has an area 52. The area 52 may be the surrounding floor space of the AGV 50 that may be monitored as well. In such a scenario, the output of the sensor arrangement 20 can also be used for collision avoidance of the (driverless) AGV vehicle 50.

The movement of the sensor arrangement 20 is coordinated with a movement of the autonomously guided vehicle 50, wherein the first field of view 25 of the sensor arrangement 20 covers the area 52 in driving direction of the autonomously guided vehicle 50. In other words, the sensor arrangement 20 is configured to make a movement that is coordinated with the movement of the AGV 50.

In this context, it should be noted and optionally, if additional axes are used for the sensor mount, then the additional axes can be controlled such that the sensor arrangement 20 keeps looking in driving direction 54 of the vehicle 50 regardless of motion of the robot manipulator arm 13. Further, in an optimal embodiment, if the robot manipulator arm 13 is kept in a rest position, while driving then the rest position can be set such that the sensor points in driving direction.

Optionally, while driving the AGV 50, if the robot manipulator arm 13 is not used for other tasks then it can dynamically move and point the camera in driving direction, this can be advantageous when the vehicle is multidirectional.

Further, when approaching tables or workstations or working alongside them there might be situations when parts of the workstation obstruct the view, e.g. a protruding shelf or worktable. Then when mounted accordingly the robot manipulator arm 13 re-positions the sensor arrangement 20 such that it can see in the direction of driving 54 of the vehicle 50.

The robot arrangement 100 may be further configured to trigger a safety-related action of the robot arm arrangement 10 on basis of a safety information provided to the sensor arrangement 20, when an object 40, e.g. a human being or an object of the working environment of the robot arrangement 100 is detected in a predefined safety zone 28 of the sensor arrangement 20. The safety-related action may be for example a speed reduction of the robot arm arrangement 10, a safe stop of movement of the robot arm arrangement 10, a change of configuration of the robot arm arrangement 10 or a performance a so-called null-space motion in order to minimize or eliminate movement of the robot arm arrangement 10 into occluded spaces outside the defined workspace 15 of the robot arm arrangement 10.

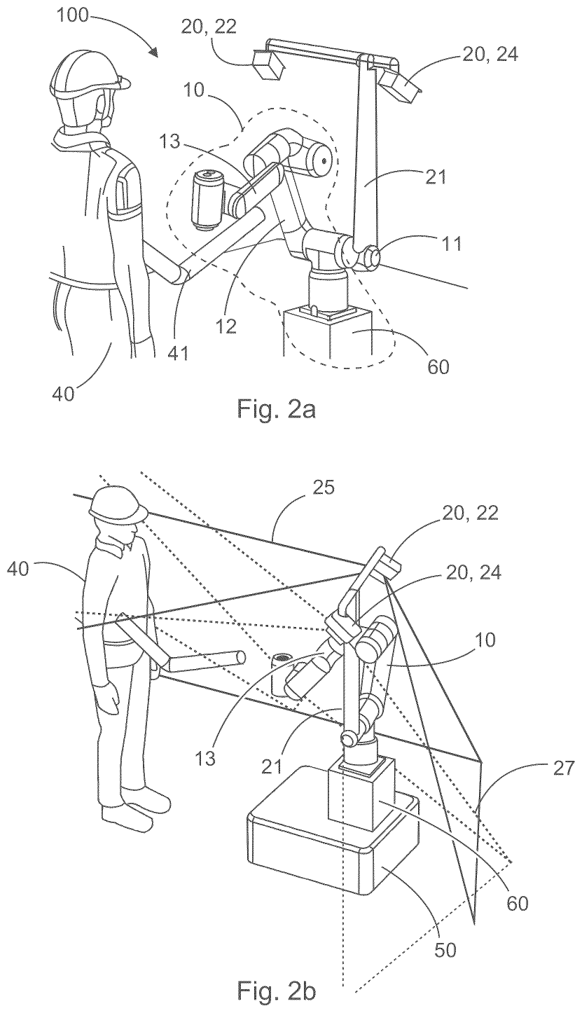

FIGS. 2a, 2b, and 2c illustrate a robot arrangement 100 with a base 60 according to a second embodiment of the present invention. The base 60 is stationary but could also be part of the vehicle 50.

The difference of the embodiment of FIG. 2a-2c compared to the embodiment shown in FIG. 1 is that the sensor arrangement 20 comprises a further second sensor device 24 that is positioned in certain distance and in a different position to the first sensor device 22. Additionally or alternatively, there are mirrors installed within the field of view to allow to monitor obscured parts of the workspace 15 of the robot arm arrangement 10. When this embodiment is used with the robot arm manipulator 13 on the vehicle 50, then the surrounding floor-space of the vehicle 50 can be monitored. Therefore, the sensor output can also be used for collision avoidance of the vehicle 50.

Also shown in FIG. 2a to FIG. 2c is a person 40 in proximity of the embodiment, and a placeholder 41 of the approximate position of the person's right arm if reaching out into the workspace 15 of the manipulator 13. According to FIG. 2b, the second sensor device 24 provides a second field of view 27 that covers a second portion 18 of the workspace 15 of the robot arm arrangement 10.

FIG. 2c illustrates the field of view 25 of the first sensor device 22, and the field of view 27 of the second sensor device 24 of the embodiment and scene as shown in FIGS. 2b and 2a.

According to FIG. 2c, the second sensor device 24 eliminates blind spots not covered or detected by the first sensor device 22 monitoring the first portion 16 of the workspace 15 of the robot arm arrangement 10. This is illustrated by the placeholder 41 of an arm of a person 40 which cannot be seen by the first sensor device 22 but by the second sensor device 24.

Therefore, when using the two sensor devices 22, 24 attached to the sensor pole 21 intersecting fields of view are created to eliminate blind spots. Thus, with these two or more sensor devices 22, 24, the monitored region of workspace 15 of the robot arm arrangement 10 can be increased. The first sensing device 22 and/or the second sensing device 24 may preferably be a 3D time of flight sensor.

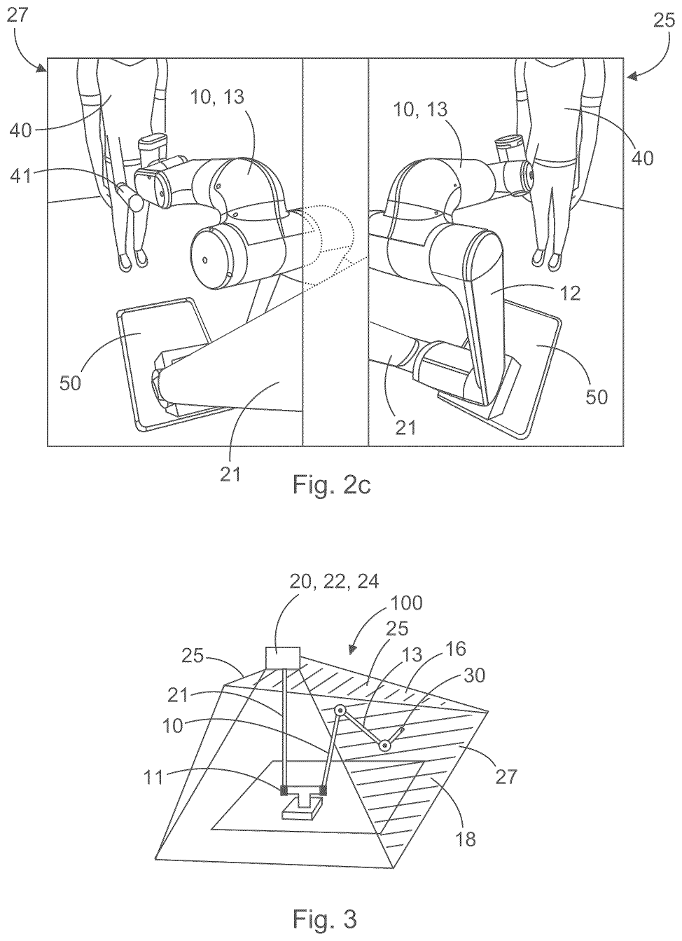

FIG. 3 illustrates a robot arrangement 100 according to a third embodiment of the present invention. In this embodiment (as well as in FIG. 2), the sensor devices 22, 24 are mounted on an extension 21 that can be a sensor pole. The sensor pole provides an elevated viewpoint for both sensor devices 22, 24. Alternatively, only one sensor device can be mounted on the sensor pole 21, wherein the other sensor device may be installed at another position at the robot arrangement 100, e.g. on the robot arm arrangement 10.

The sensor pole or extension 21 can be installed on the independent joint 11 as an independent axe which is controlled by a robot controller of the robot arrangement 100. This allows the extension 21 to move vertically or at other preferred angles or positions relative to the robot arm arrangement 10.

The embodiment of FIG. 3 further shows that each of the first sensor device 22 and the second sensor device 24 cover or monitor different parts of the workspace 15 of the robot arm arrangement 10. For example, the first sensor device 22 with a first field of view 25 monitors the first portion 16 of workspace 15 of the robot arm arrangement 10 and the second sensor device 24 with a second field of view 27 monitors the second portion 18 of workspace 15 of the robot arm arrangement 10. In this way, the two sensor devices 22, 24 on the sensor pole 21 allow to build intersecting fields of view to eliminate blind spot spaces that are invisible to one sensor, because of obstruction by link elements of the robot manipulator 13, but are visible for the other sensor.

Optionally, if parts of the sensor pole 21 intersect with the motion range of the robot manipulator 13 or a tool 30, then the motion range is limited by the robot controller in order to prevent the manipulator 12 hitting the sensor pole 21.

It should be further mentioned that occluded areas in the workspace (blind spots) are calculated permanently during the motion of the robot arm arrangement 10. If the motion of the robot arm arrangement 10 paths leads into occluded areas, then robot speed is reduced such that a possible collision with a person does not exceed safe limits and therefore will not cause injury. Otherwise, if the robot path runs through the workspace 15 that is monitored and not occluded then the robot arrangement 100 is kept at full speed.

It should be noted in this context that if a tool or workpiece 30 is moved by the robot manipulator arm 13, then their volume is added to calculation of occluded space during a motion of the robot arm arrangement 10.

The robot arm arrangement in the sense of the present invention can be regarded as a robot manipulator arm including end-of-arm tool, workpiece, and other attachments.

In the following, further aspects of the present invention are explained.

An important aspect in view of the present invention is that robot manipulators have a large working envelope or 3D motion range or volume around their base, but do occupy only a small portion of that volume at a time. For collision avoidance and safety, it is sufficient to monitor this small portion including some volume around it and some volume in the direction of motion.

This can be achieved, if one or more safety sensors with only limited field of view are installed at one or more of the link elements of the robot manipulator or robot arm arrangement. Optionally, the sensors may be mounted on one or more additional joints of the robot arrangement to increase the control of the monitored space at any time.

For the present invention, it is assumed that an arrangement of one or more sensors has a field of view with a horizontal and a vertical extension—unlike a 2D laser scanner which has only a horizontal extension. Preferably, the sensors of the sensor arrangement can be used for safety functions. Examples of such 3D sensors are solid state lidar sensors or radar sensors.

The sensor arrangement of the present invention is placed such that it observes only the space where motion of the robot arm arrangement occurs which includes a hazard zone. Typically, this is possible from an elevated viewpoint of a so-called sensor pole on which the sensor arrangement may be installed. At the upper end of this sensor pole, the sensor arrangement is mounted which looks downwards onto the scene which includes all body parts of the robot manipulator or the robot arm arrangement including tools and workpieces and their perimeter.

In this way, the present invention provides the advantage that in an efficient way only the relevant part or portion of workspace of the robot arm arrangement meaning the relevant region of movement of the robot arm arrangement is continuously monitored by the sensor arrangement. In this way, it can be ensured that collisions of the robot arm arrangement with objects within said workspace of the robot arm arrangement or or hazardous situations in the environment of the robot arm arrangement are prevented. Therefore, the safety when operation the robot arrangement can be enhanced.

A further advantage of the present invention is that changes in the workspace of the robot arm arrangement, e.g. when a new tool is installed on the robot arm arrangement, can be easily applied to the sensor arrangement resulting in an efficient motion monitoring of the robot arm arrangement.

According to an example, the sensor arrangement is installed on a moving part the robot arm arrangement. In this way, the advantage of an efficient motion monitoring of the robot arm arrangement is ensured.

According to an example, the sensor arrangement is mounted on an at least one independent joint of the robot arm arrangement that is configured to be aligned in or corresponding to the first portion of the workspace of the robot arm arrangement. In this way, the advantage of an efficient motion monitoring of the robot arm arrangement is ensured and an efficient monitoring of a relevant 3D coverage of the robot arm arrangement can be applied.

According to an example, wherein the sensor arrangement is configured as an extension which allows to mount the at least first sensor device at a defined distance relative to the robot arm arrangement on which the at least first sensing device is mounted to monitor the at least first portion of the workspace of the robot arm arrangement. In this way, the advantage is achieved that the at least first portion of the workspace of the robot arm arrangement can be effectively monitored.

According to an example, the robot arm arrangement comprises a robot manipulator arm and/or a tooling member installed on the robot manipulator arm. In this way, the to-be monitored portion of the workspace of the robot arm arrangement can be clearly defined.

According to an example, the sensor arrangement comprises a second sensor device providing a second field of view that covers a second portion of the workspace of the robot arm arrangement. In this way, the advantage is achieved that portions or regions of the workspace of the robot arm arrangement are effectively monitored that are not covered or monitored by the first sensor device. In this way, the monitored 3D motion range of the robot arm arrangement is effectively increased.

According to an example, the second sensor device is covering the same 3D region, but from a different point of view, which allows the monitoring of sub-regions that are hidden by the robot arm or other objects for the first sensor device.

According to an example, the robot arrangement is configured to trigger a safety-related action of the robot arm arrangement on basis of a safety information provided to the sensor arrangement, when an object is detected in a predefined safety zone of the sensor arrangement. In this way, the advantage is achieved that a safe operation of the robot arm arrangement can be ensured.

According to an example, the movement of the at least one independent joint is in such a way that the first field of view of the sensor arrangement covers the at least the first portion of the workspace of the robot arm arrangement. In this way, the advantage of an efficient motion monitoring of the robot arm arrangement is ensured.

According to an example, the movement of the at least one independent joint is coordinated with the movement of the robot arm arrangement and a movement of the robot arrangement. In this way, the advantage of an efficient motion monitoring of the robot arm arrangement is ensured.

According to an example, the robot arrangement includes an autonomously guided vehicle on which the robot arm arrangement is installable. In this way, the advantage is achieved that the robot arm arrangement can be easily applied to different production scenarios.

According to an example, the movement of the sensor arrangement is coordinated with a movement of the autonomously guided vehicle, wherein the field of view of the sensor arrangement covers an area in driving direction of the autonomously guided vehicle. In this way, the advantage is achieved that a motion monitoring of the robot arrangement (including the mobile platform and the robot arm arrangement) with a changing workspace of the robot arrangement can be effectively adapted.

In a second aspect of the present invention, a method for an automated motion monitoring of a robot arrangement is provided.

In a third aspect of the present invention, a computer comprising a processor configured to perform the method according to the second aspect is provided.

In a fourth aspect of the present invention, a computer program product is provided comprising instructions which, when the computer program is executed by a processor of a computer, causes the computer to control the method of the second aspect and/or the robot arrangement according of the first aspect.

In a fifth aspect, a machine-readable data medium and/or download product is provided containing the computer program according to the fourth aspect.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### REFERENCE SIGNS

10 Robot arm arrangement
11 Independent joint
12 Moving part
13 Robot manipulator arm
15 Workspace
16 First portion of workspace/Region of movement
18 Second portion of workspace
20 Sensor arrangement
21 Extension
22 First sensor device
24 Second sensor device
25 First field of view
27 Second field of view
28 Safety zone
30 Tooling member
40 Object or person
41 Placeholder for arm of person
50 Autonomously guided vehicle (AGV)
52 Area of the autonomously guided vehicle
54 Driving direction
60 Base
100 Robot arrangement
200 Method

What is claimed is:

1. A robot arrangement, comprising:
at least a movable robot arm arrangement configured to move within a workspace defining a 3D motion range;
a sensor arrangement disposed on the robot arm arrangement and comprising at least a first sensor device providing at least a first field of view;
wherein the sensor arrangement is configured to be moved such that the at least first field of view of the sensor arrangement covers at least a first portion of the workspace defining a first region of movement of the robot arm arrangement.

2. The robot arrangement according to claim 1, wherein the sensor arrangement is disposed on a moving part of the robot arm arrangement.

3. The robot arrangement according to claim 2, wherein the sensor arrangement is mounted on an at least one independent joint of the robot arm arrangement that is configured to be aligned in or corresponding to the first portion of the workspace of the robot arm arrangement.

4. The robot arrangement according to claim 1, wherein the sensor arrangement is configured as an extension that allows mounting of the at least first sensor device at a distance relative to the robot arm arrangement on which the at least first sensing device is configured to monitor the at least first portion of the workspace of the robot arm arrangement.

5. The robot arrangement according to claim 1, wherein the robot arm arrangement comprises a robot manipulator arm and/or a tooling member installed on the robot manipulator arm.

6. The robot arrangement according to claim 1, wherein the sensor arrangement comprises a second sensor device providing a second field of view that covers a second portion of the workspace of the robot arm arrangement.

7. The robot arrangement according to claim 1, wherein the robot arrangement is configured to trigger a safety-related action of the robot arm arrangement based on a safety information provided by the sensor arrangement when an object is detected in a predefined safety zone of the sensor arrangement.

8. The robot arrangement according to claim 3, wherein movement of the at least one independent joint permits the first field of view of the sensor arrangement to cover the at least first portion of the workspace of the robot arm arrangement.

9. The robot arrangement according to claim 3, wherein movement of the at least one independent joint is coordinated with movement of the robot arm arrangement and a movement of the robot arrangement.

10. The robot arrangement according to claim 1, wherein the robot arrangement is an autonomously guided vehicle on which the robot arm arrangement is installable.

11. The robot arrangement according to claim 10, wherein the movement of the sensor arrangement is coordinated with a movement of the autonomously guided vehicle, and wherein the field of view of the sensor arrangement covers an area in a driving direction of the autonomously guided vehicle.

12. A method for an automated motion monitoring of a robot arrangement, the method comprising:
providing at least a movable robot arm arrangement configured to move within a workspace defining a 3D motion range;
providing a sensor arrangement disposed on the robot arm arrangement and comprising at least a first sensor device providing at least a first field of view;
moving the sensor arrangement such that the at least first field of view of the sensor arrangement covers at least a first portion of the workspace defining a first region of movement of the robot arm arrangement.

13. A computer program product comprising instructions which, when the computer program is executed by a processor of a computer, causes the computer to carry out a method for an automated motion monitoring of a robot arrangement, the method comprising:
for at least a movable robot arm arrangement that configured to move within a workspace defining a 3D motion range;
providing a sensor arrangement disposed on the robot arm arrangement and comprising at least a first sensor device and instructions for providing at least a first field of view;
instructions for moving the sensor arrangement such that the at least first field of view of the sensor arrangement covers at least a first portion of the workspace defining a first region of movement of the robot arm arrangement.
